(19) United States
(12) Patent Application Publication
(10) Pub. No.: US 2015/0175068 A1
(43) Pub. Date: Jun. 25, 2015

(54) SYSTEMS AND METHODS FOR AUGMENTED REALITY IN A HEAD-UP DISPLAY

(71) Applicants: Dalila Szostak, Portland, OR (US); Jose K. Sia, JR., Hillsboro, OR (US); Victoria S. Fang, Mountain View, CA (US); Alexandra C. Zafiroglu, Portland, OR (US); Jennifer A. Healey, San Jose, CA (US); Sarah E. Fox, Cartersville, GA (US); Juan I. Correa, San Francisco, CA (US); Alejandro Abreu, Tempe, AZ (US); Maria Paula Saba Dos Reis, New York, NY (US)

(72) Inventors: Dalila Szostak, Portland, OR (US); Jose K. Sia, JR., Hillsboro, OR (US); Victoria S. Fang, Mountain View, CA (US); Alexandra C. Zafiroglu, Portland, OR (US); Jennifer A. Healey, San Jose, CA (US); Sarah E. Fox, Cartersville, GA (US); Juan I. Correa, San Francisco, CA (US); Alejandro Abreu, Tempe, AZ (US); Maria Paula Saba Dos Reis, New York, NY (US)

(21) Appl. No.: 14/361,188

(22) PCT Filed: Dec. 20, 2013
(86) PCT No.: PCT/US2013/077229

§ 371 Date: May 28, 2014

(51) Int. Cl. B60Q 9/00; G06T 19/00

(52) U.S. Cl. CPC B60Q 9/008; G06T 19/006

(57) ABSTRACT

Disclosed are systems and methods for augmenting reality in a head-up display implemented using a windshield of a vehicle. Image data of an operator of the vehicle is captured and a gaze tracker processes the operator image data to determine a direction of the gaze of the operator. Image data of the environment ahead of the vehicle is captured. An environment analyzer processes the environment image data. Augmented reality (“AR”) data is received from an external network. The AR data is associated with an object ahead of the vehicle and within the current area of central vision of the operator. A projection system presents AR data on the windshield to appear, to the operator of the vehicle, to be associated with the object.

### TECHNICAL FIELD

Embodiments described herein generally relate to head-up displays. More particularly, the disclosed embodiments relate to systems and methods for providing augmented reality in head-up displays.

### BACKGROUND

A head-up display (“HUD”) is any transparent display that presents data without requiring a viewer to look away from customary viewpoints. The origin of the name stems from a pilot being able to view information on a display with the head positioned “up” and looking forward, instead of angled down looking at lower instruments. A windshield of a vehicle (e.g., automobile, aircraft, boat, truck, or other vehicle) can include HUD functionality. A HUD can provide a platform for augmented reality.

Augmented reality (“AR”) is a live, direct or indirect, view of a physical, real-world environment in which elements of the environment are augmented (or supplemented), for example, by computer-generated sensory input such as text, graphics, video, sound, or other data.

Current AR systems that are implemented using a windshield of a vehicle as a HUD can merely display information in a limited area of the windshield and only display information that can be easily gleaned from the vehicle's internal systems (e.g., speedometer, odometer, trip meter, fuel tank level, etc.).

Where AR and/or HUD are not implemented, information is presented to a vehicle operator (e.g., a driver of an automobile, a pilot of an aircraft) on one or more screens, usually on a dashboard or center console, which can distract the operator. Also, information is available on phones, personal navigation devices, tablets, personal digital assistants, and other mobile computing devices, which may be even more dangerous while driving.

### BRIEF DESCRIPTION OF THE DRAWINGS

FIGS. 1A-1C illustrate a vehicle that presents augmented reality in a head-up display, according to one embodiment.

FIG. 2 is a schematic diagram of a system for presenting augmented reality in a head-up display, according to one embodiment.

FIG. 3 is a flow diagram of a method for presenting augmented reality in a head-up display, according to one embodiment.

FIGS. 4A and 4B illustrate an example of a windshield displaying augmented reality data, according to one embodiment.

FIG. 5 illustrates an example of a windshield displaying augmented reality data, according to another embodiment.

FIG. 6 illustrates an example of a windshield displaying augmented reality data, according to another embodiment.

### DETAILED DESCRIPTION OF PREFERRED EMBODIMENTS

Presently, information is typically presented to an operator of a vehicle (e.g., an automobile, an aircraft, a truck, a semi-trailer, a bus, a train, a motorcycle, a boat, or another vehicle for transport) on one or more screens, usually on a dashboard or center console, which can distract the vehicle operator. Information is also available, and may be presented, on phones, personal navigation devices, tablets, personal digital assistants, and other mobile computing devices, which may pose an even more dangerous distraction.

A head-up display (“HUD”) offers an alternative to these forms of presentation, and a windshield of a vehicle can include or otherwise provide HUD functionality. Augmented reality (“AR”) functionality implemented using a windshield as a HUD can minimize distraction resulting from providing AR data to a vehicle operator.

Presently, AR systems implemented in a HUD using a windshield of a vehicle can merely display information in a limited area of the windshield and only display information that can be easily gleaned from the vehicle's internal systems (e.g., speedometer, odometer, trip meter, fuel tank level, etc.). Moreover, presenting AR information on the windshield presents challenges to safety, because the system may unintentionally overlay AR information in a way that blocks, shields, or otherwise occludes important real-world objects like an approaching vehicle, a road sign, or a pedestrian. This challenge to safety would be further exacerbated were the entire windshield operating as an AR HUD. The present inventors recognized the foregoing challenges in presenting information to a vehicle operator.

The disclosed embodiments can present AR data in any portion of a windshield HUD. While existing HUDs in vehicles are limited to a particular area of the windshield, the disclosed embodiments are configured to display at any area of the windshield, including adjacent any edge (e.g., top, bottom, left side, right side) of the windshield. Various techniques can be used to display AR data in a manner to minimize driver distraction and to avoid diverting the driver's attention to another area of the windshield from where the driver may be presently gazing.

The disclosed embodiments can overlay information onto the environment itself in such a way that it appears that the information is actually disposed on (e.g., painted onto) the exterior of objects in the environment. For example, navigation information indicating to the vehicle operator to take a particular exit can be displayed on the windshield in such a way that it appears to the driver that the indicator is painted onto an exit sign in the environment. Displaying AR information in this manner alleviates the possibility that AR information could occlude objects, which may be dangerous while driving, and also visually associates information with corresponding objects in the environment. This helps keep the driver's attention focused outward on the road instead of inside the vehicle or on a small HUD in a small portion of the windshield.

In some disclosed embodiments, gaze-tracking technology enables certain information to be displayed only in a region where the driver is currently gazing and to be limited or blocked from other areas or regions to avoid cluttering the vehicle operator's view through the windshield. A gaze, or gazing, of an operator refers to focused viewing of the operator. The operator's gaze results in a visual field of the operator and includes a line of sight (e.g., the aim or direction of the gaze, which may define an optical center of the visual field and which may correspond to an optical axis, or an optical centerline of the operator's gaze), central vision (e.g., area within the gaze, around the optical center or line of sight, that appears in focus), and peripheral vision (e.g., area within the gaze that appears out of focus).

The disclosed embodiments can display AR information in a windshield HUD in a manner that can communicate and/or draw attention without distracting the vehicle operator and/or without increasing the mental load of the vehicle operator. The presently disclosed embodiments display AR information in a windshield HUD in a manner that utilizes existing visual cues rather than increasing visual cues. The presently disclosed embodiments display AR information in a windshield HUD in a manner that can utilize ambient information and varying levels of light to prominently or subtly call out pertinent information.

The disclosed embodiments obtain data, such as AR data, from data sources external to the vehicle. For example, the disclosed embodiments include a network interface configured to form a wireless data connection with a wireless network access point disposed in the environment external to the vehicle. The network interface may receive, via the wireless data connection, AR data pertinent to the environment near the vehicle, such as the environment visible to the operator through the windshield of the vehicle. The wireless network access point may be coupled to a network that may provide data pertaining to the environment near the vehicle, such as the time remaining on parking meters, the toll to access a toll road, the wait time to be seated at a restaurant, store hours of nearby businesses, and the like.

With reference to the above-listed drawings, particular embodiments and their detailed construction and operation are described herein. The embodiments described herein are set forth by way of illustration only and not limitation. It should be recognized in light of the teachings herein that other embodiments are possible, variations can be made to the embodiments described herein, and there may be equivalents to the components, parts, or steps that make up the described embodiments.

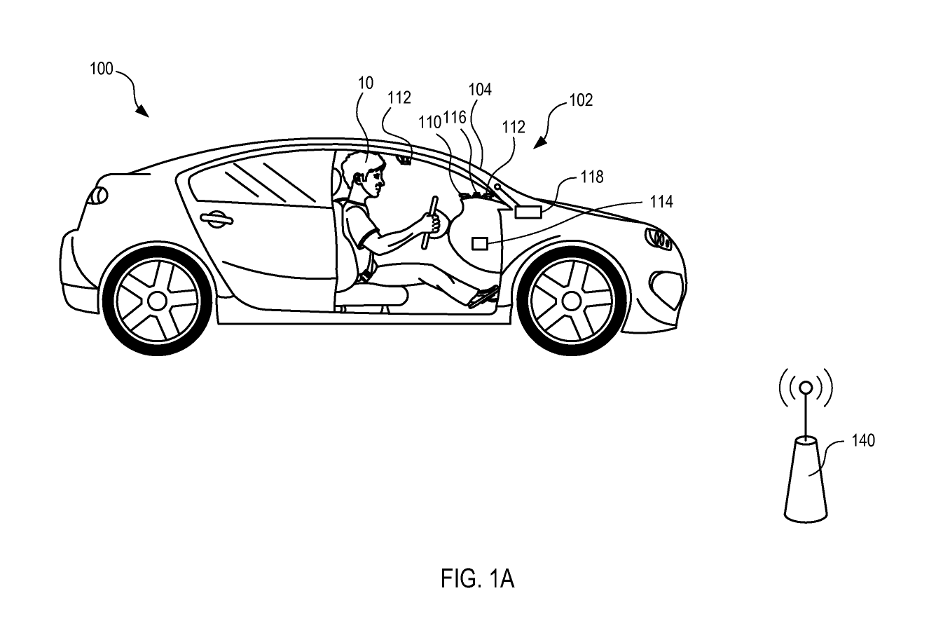

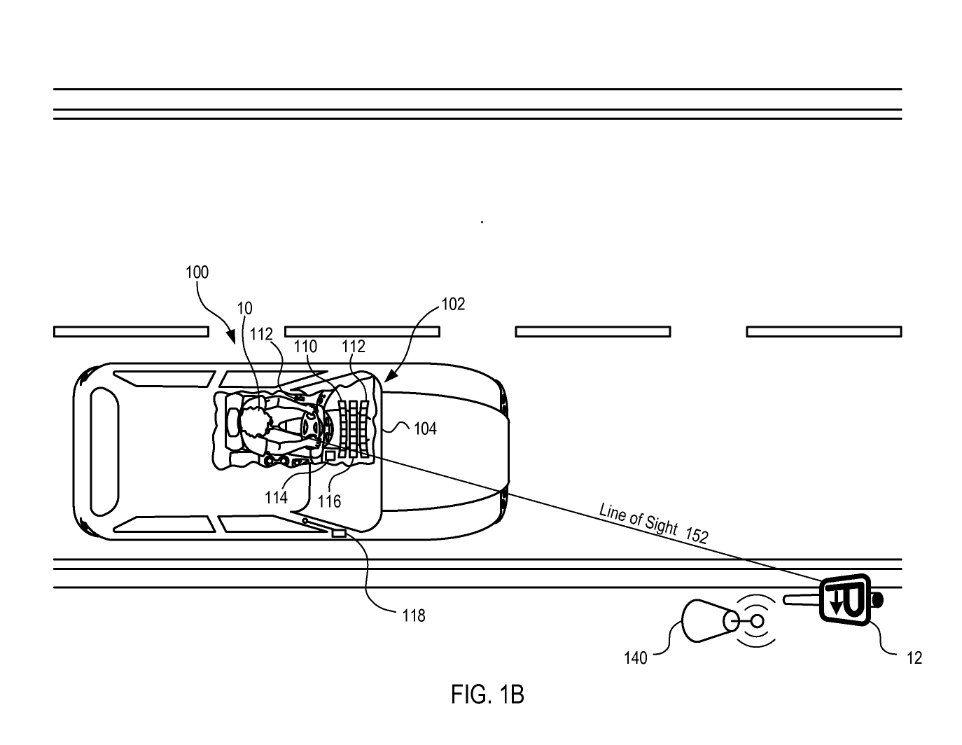

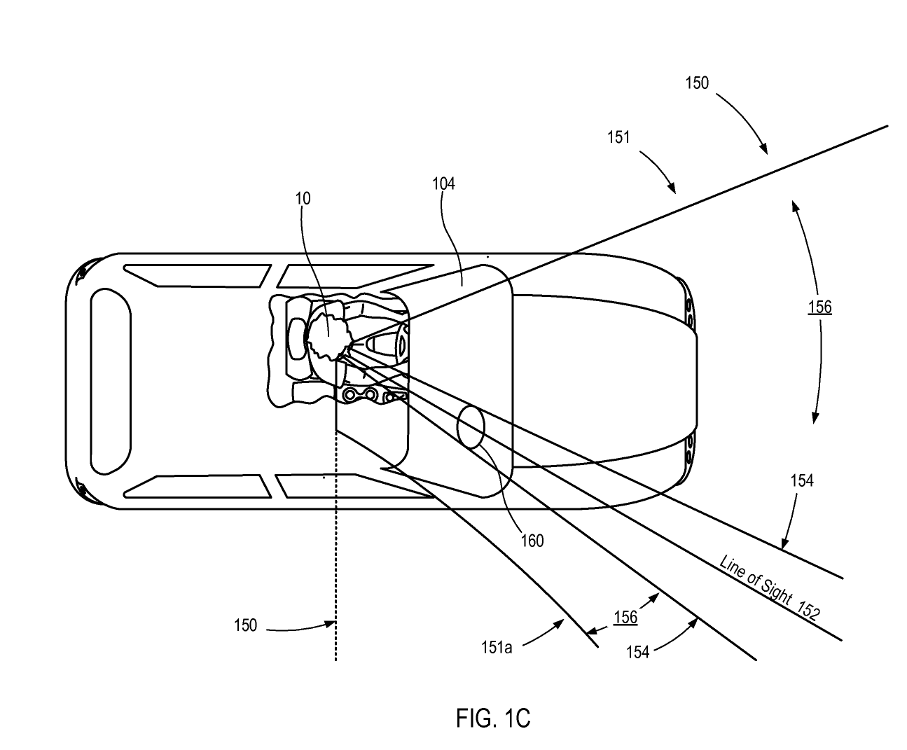

FIGS. 1A-1C illustrate a vehicle 100 that presents AR data using a windshield 104 as a HUD, according to one embodiment. FIG. 1A is a side partial cut-away view of the vehicle 100. FIG. 1B is a top partial cut-away view of the vehicle 100. FIG. 1C is a close-up of FIG. 1B and illustrating a diagrammatic representation of a gaze of the operator 10 of the vehicle. The vehicle 100 may include a windshield 104 and a system 102 for presenting AR data using the windshield 104 as a HUD.

The system 102 for presenting AR data using the windshield 104 as a HUD of FIGS. 1A-1C includes an internal facing image capture system 110, an external facing image capture system 112, a controller 114, a projection system 116, and a network interface 118.

The internal facing image capture system 110 captures image data of an operator 10 of the vehicle 100. The internal facing image capture system 110 may include an imager or a camera to capture images of the operator 10. In certain embodiments, the internal facing image capture system 110 may include one or more array cameras.

The image data captured by the internal facing image capture system 110 can be used for various purposes. The image data may be used to identify the operator 10 for obtaining information about the operator 10, such as a head position (or more particularly a position of the eyes) of the operator 10 relative to the windshield 104. Alternatively, or in addition, the image data may be used to detect a position (e.g., height, depth, lateral distance) of the head/eyes of the operator 10. The image data may also be used to detect and/or track a current gaze of the operator 10. The head/eye position and data specifying the gaze of the operator can be used for determining what AR data to display and where and/or how to display the AR data on the windshield 104, as will be explained.

The external facing image capture system 112 captures image data of an environment in front of the vehicle 100. The external facing image capture system 112 may include an imager or a camera to capture images of an area external to the vehicle. The external facing image capture system 112 may include multiple imagers at different angles to capture multiple perspectives. The external facing image capture system 112 may also include multiple types of imagers, such as active infrared imagers and visible light spectrum imagers. Generally, the external facing image capture system 112 captures images of an area in front of the vehicle 100, or ahead of the vehicle in a direction of travel of the vehicle 100. In certain embodiments, the external facing image capture system 112 may include one or more array cameras.

The image data captured by the external facing image capture system 112 can be analyzed or otherwise used to identify objects in the environment around the vehicle 100 (e.g., generally in front of the vehicle, or ahead of the vehicle in a direction of travel of the vehicle). AR data can be associated with portions of the image data and/or objects identified in the image data. The image data can enable projection or display of AR data overlayed over the top of the external environment as viewed by the operator 10.

The controller 114 receives operator image data captured by the internal facing image capture system 110 and processes the operator image data to identify the operator 10, detect a head/eye position of the operator 10, and/or to detect and/or track a current gaze of the operator 10. The controller 114 also receives environment image data captured by the external facing image capture system 112 and analyzes or otherwise processes the environment image data to identify objects in the environment around the vehicle 100 (e.g., generally in front of the vehicle, or ahead of the vehicle in a direction of travel of the vehicle). The controller also receives AR data associated with objects in the environment near or around the vehicle 100. The controller uses the received environment image data and the received AR data and associates the AR data with portions of the environment image data and/or objects identified in the environment image data. The controller 114 uses the received operator image data to determine where and/or how AR data is displayed on the windshield 104. The controller 114 may determine how to display AR data overlayed over the top of the external environment as viewed by the operator 10.

The controller 114 may also receive and/or access vehicle data (such as the speed of the vehicle). The vehicle data may be presented to supplement or augment presentation of the AR data (or otherwise enhance the AR experience of the operator). For example the vehicle speed could be used to augment how the overlay and/or or registration of the AR with the real world would be likely to move with respect to the operator's gaze as the vehicle moves.

The controller 114, in cooperation with the projection system 116, presents a portion of AR data that is associated with an object that is in the environment ahead of the vehicle and that is likely within the central vision of the operator 10, based on a determined line of sight 152 of the current gaze 150 of the operator 10. The controller 114, in cooperation with the projection system 116, can ensure that the AR data that is presented is displayed within, and pertains to an object that is likely within, the central vision of the operator 10 rather than the peripheral vision, based on the determined line of sight 152 of the current gaze 150 of the operator 10. AR data pertaining to objects that are likely outside of the central vision of the operator, or in the peripheral vision of the operator, may be excluded or otherwise not displayed to the operator 10.

The projection system 116 presents AR data on the windshield 104 of the vehicle 100. As noted, the projection system 116, in conjunction with the controller 114, displays the AR data overlayed over the top of the external environment as viewed by the operator 10, such that the displayed portion of AR data is viewed and understood by the operator 10 as associated with an object that is in the environment ahead of the vehicle 100. As noted, the projection system 116, in cooperation with the controller 114, can present AR data within, and pertaining to an object that is likely within, the central vision of the operator 10, based on the determined line of sight 152 of the current gaze 150 of the operator 10. The AR data is displayed by the projection system 116 on the windshield 104 of the vehicle 100 corresponding to the line of sight of the operator and displayed to appear, to the operator of the vehicle, to be associated with the object.

As an example, the AR data received may be pertinent to the parking sign 12 (shown in FIG. 1B), such as AR data indicating how many parking spaces are available in the parking lot(s) associated with the sign 12. The controller 114 may process the environment image data to detect the sign 12, correlate the AR data with the sign 12, determine whether the parking sign 12 is within and in the direction of the operator's current gaze, and determine that the projection system 116 should display the AR data overlayed over the sign 12 or in close association with the sign 12.

The network interface 118 is configured to receive AR data pertaining to the environment external to and near the vehicle 100. The network interface 118 forms a wireless data connection with a wireless network access point 140 disposed externally to the vehicle 100. A portion of the received AR data may be pertinent to the environment visible to the operator through the windshield of the vehicle. For example, the network interface 118 may receive AR data pertinent to a sign 12 (shown in FIG. 1B). In FIG. 1B, the sign 12 is a parking sign, so the AR data may be information concerning how many parking spaces are available in the parking lot(s) associated with the sign 12.

The network interface 118 may connect with a wireless network access point 140 coupled to a network, such as a local area network (LAN), a wide area network (WAN), or the Internet. In certain embodiments, the wireless network access point 140 is on or coupled to a geographically localized network that is isolated from the Internet.

In certain embodiments, the wireless network access point 140 is coupled to a “cloudlet” of a cloud-based distributed computing network. A cloudlet is a computing architectural element that represents a middle tier (e.g., mobile device - - - cloudlet - - - cloud). Cloudlets are decentralized and widely-dispersed Internet infrastructure whose compute cycles and storage resources can be leveraged by nearby mobile computers. A cloudlet can be viewed as a local “data center” that is designed and configured to bring a cloud-based distributed computing architecture or network closer to a mobile device (e.g., in this case the controller 114 or the system 102) and that can provide compute cycles and storage resources to be leveraged by nearby mobile devices. A cloudlet may have only soft state, meaning it does not have any hard state, but may contain cached state from the cloud. It may also buffer data originating from one or more mobile devices en route to safety in the cloud. A cloudlet may possess sufficient computing power (i.e., CPU, RAM, etc.) to offload resource-intensive computations from one or more mobile devices. The cloudlet may have excellent connectivity to the cloud (typically a wired Internet connection) and generally is not limited by finite battery life (e.g., it is connected to a power outlet). A cloudlet is logically proximate to the associated mobile devices. “Logical proximity” translates to low end-to-end latency and high bandwidth (e.g., one-hop Wi-Fi). Logical proximity may imply physical proximity. A cloudlet is self-managing, requiring little more than power, Internet connectivity, and access control or setup. The simplicity of management may correspond to an appliance model of computing resources, and makes trivial deployment on a business premises such as a coffee shop or a doctor's office. Internally, a cloudlet may be viewed as a cluster of multi-core computers, with gigabit internal connectivity and a high-bandwidth wireless LAN.”

In certain embodiments, the wireless network access point 140 is coupled to a fog of a cloud-based distributed computing network. A fog may be more extended than a cloudlet. For example, a fog could provide compute power from “ITS” (Intelligent Transportation Systems) infrastructure along the road: e.g. a uploading/downloading data at a smart intersection. The fog may be contained to peer-to-peer connections along the road (i.e., not transmitting data to the “cloud” or a remote data center), but would be extended along the entire highway system and the vehicle may engage and disengage in local “fog” compute all along the road. Described differently, a fog may be a distributed, associated network of cloudlets.

As another example, a fog may offer distributed computing through a collection of parking meters, where each individual meter may be an edge of the fog and may establish a peer-to-peer connection with a vehicle. The vehicle may travel through a “fog” of edge computing provided by each parking meter.

In certain other embodiments, the network interface 118 may receive AR data from a satellite (e.g., global positioning system (GPS) satellite, XM radio satellite). In certain other embodiments, the network interface 118 may receive AR data from a cell phone tower. As can be appreciated, other appropriate wireless data connections are possible.

Referring specifically to FIG. 1C, the controller 114 may determine and/or track the operator's gaze 150 and may determine where and/or how AR data is displayed on the windshield 104, as noted above. The controller 114 may process the received operator image data to determine and/or track a current gaze 150 of the operator 10 of the vehicle 100. The current gaze 150 may be characterized by a visual field 151 and a line of sight 152 (e.g., the aim or direction of the gaze 150, which may define an optical center of the visual field and which may correspond to an optical axis, or an optical centerline of the operator's current gaze 150). FIG. 1C illustrates that the visual field 151 of the environment ahead of the vehicle through the windshield 104 may be limited by a frame around the windshield 104, such that one edge 151a (or more than one edge) of the visual field 151 is more narrow or less expansive than otherwise. Within the visual field 151 of the operator 10, there is an area of central vision 154 (e.g., area within the gaze 150, around the optical center or line of sight, that appears in focus) and areas of peripheral vision 156 (e.g., areas within the gaze 150, but on the periphery of the gaze 150, that appear out of focus). In FIG. 1C, the operator's gaze 150 (and thus the line of sight and area of central vision) may be directed to a right side of the road, for example, to a road sign (e.g., the sign 12 in FIG. 1B).

The controller 114 may receive operator image data captured by the internal facing image capture system 110 and process the operator image data to detect and/or track a current gaze 150 of the operator 10. The operator's current gaze 150 may be detected by analyzing operator image data of a face of the operator and in particular image data of the eyes of the operator. A position of the head and/or eyes may be determined relative to the body and/or head within the operator image data and/or relative to a fixed point of an imager (e.g., an optical center of an imager). The line of sight 152 of the gaze 150 may be detected. From the line of sight 152, the controller 114 may calculate the visual field 151 of the operator 10, taking into account constraints of the windshield 104. The controller 114 may calculate an area of central vision 154. For example, the area of central vision 154 may be calculated as an angle away from the line of sight 152. The angle may vary as a function of a distance of an object or environment) from the operator 10. A distance of an object (or environment) may be determined by the controller 114 by receiving and processing environment image data. The controller 114 can then determine where and/or how AR data is displayed on the windshield 104.

The controller 114 may determine how to display AR data overlayed over the top of the external environment as viewed by the operator 10. The controller 114, in cooperation with the projection system 116, can ensure that the AR data that is presented is displayed on an area of central vision 160 on the windshield, so as to avoid distracting the operator. The controller can further determine whether given AR data pertains to an object that is likely within the central vision of the operator 10 based on the determined line of sight 152 of the current gaze 150 of the operator 10. The controller 114 may exclude AR data pertaining to objects outside of the central vision of the operator, such as in the peripheral vision of the operator 10. The gaze tracking can enable presentation of AR information at an appropriate time and position to minimize the amount of information being presented in the operator's visual field while driving.

In the example of FIGS. 1A-1C, AR data may be received that is pertinent to the parking sign 12 (shown in FIG. 1B), such as AR data concerning how many parking spaces are available in the parking lot(s) associated with the sign 12. The controller 114 may process the environment image data to detect the sign 12, correlate the AR data with the sign 12, determine whether the parking sign 12 is within the central vision of the operator 10, and determine that the projection system 116 should display the AR data overlayed over the sign 12 or in close association with the sign 12 and within the area of central vision 160 on the windshield 104.

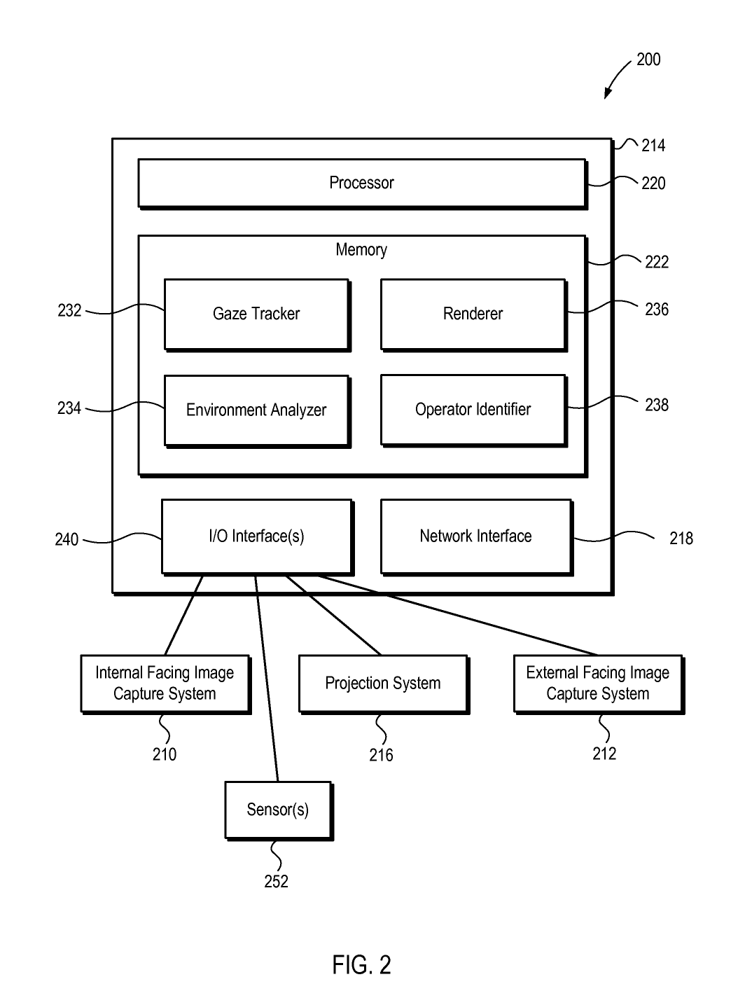

FIG. 2 is a schematic diagram of a system 200 for presenting AR in a HUD, according to one embodiment. The system 200 is operable to utilize a windshield (not shown) of a vehicle as the HUD, similar to the system 102 discussed above with reference to FIGS. 1A-1C. The system 200 includes an internal facing image capture system 210, an external facing image capture system 212, a controller 214, and a projection system 216.

The internal facing image capture system 210 is configured to capture image data of an operator of a vehicle in which the system 200 is mounted and/or operable. The internal facing image capture system 210 may include one or more imagers or cameras to capture images of the operator. In certain embodiments, the internal facing image capture system 210 may include one or more array cameras. The image data captured by the internal facing image capture system 210 can be used to identify the operator, to detect a head/eye position of the operator, and/or to detect and/or track a current gaze of the operator.

The external facing image capture system 212 captures image data of an environment in front of the vehicle. The external facing image capture system 212 may include one or more imagers or cameras to capture images of an area external to the vehicle, generally of an area in front of the vehicle, or ahead of the vehicle in a direction of travel of the vehicle. In certain embodiments, the external facing image capture system 212 may include one or more array cameras. The image data captured by the external facing image capture system 212 can be analyzed or otherwise used to identify objects in the environment around the vehicle (e.g., generally in front of the vehicle, or ahead of the vehicle in a direction of travel of the vehicle). AR data can be associated with portions of the image data and/or objects identified in the image data. The image data can enable projection or display of AR data overlayed over the top of the external environment as viewed by the operator.

The controller 214 is operable to receive and process operator image data captured by the internal facing image capture system 210, to receive and process environment image data captured by the external facing image capture system 212, to receive AR data, and to coordinate display of the AR data by the projection system 216 on the windshield of the vehicle. The controller 214 as shown in FIG. 2 includes a processor 220, a memory 222, a gaze tracker 232, an environment analyzer 234, a renderer 236, and optionally an operator identifier 238. The controller 214, as shown in FIG. 2, includes input/output (“I/O”) interfaces 240. The controller 214 may optionally include a network interface 218. In other embodiments, the controller 214 may simply couple to an external network interface 218.

The gaze tracker 232 is configured to process operator image data captured by the internal facing image capture system 210 to determine a line of sight of a current gaze of the operator of the vehicle. The gaze tracker 232 may analyze the operator image data to detect eyes of the operator and to detect a direction in which the eyes are focused. The gaze tracker 232 may continually process current operator image data to detect and/or track the current gaze of the operator. In certain embodiments, the gaze tracker 232 may process the operator image data substantially in real time.

The environment analyzer 234 processes environment image data captured by the external facing image capture system 212 and correlates AR data with the environment visible to the operator through the windshield of the vehicle. The environment analyzer 234 receives environment image data captured by the external facing image capture system 212 and analyzes or otherwise processes the environment image data to identify objects in the environment around the vehicle (e.g., generally in front of the vehicle, or ahead of the vehicle in a direction of travel of the vehicle). The environment analyzer may continually process current environment image data to maintain context with a current view or visual field of the operator. The environment analyzer 234 associates received AR data with portions of the environment image data and/or objects identified in the environment image data.

Rendering graphical data to overlay the AR data over the external environment may be performed by the controller 214 and/or the projection system 216. The renderer 236 and/or the projection system 216 may include a graphics processing unit (GPU) or other specific purpose processor or electronic circuitry for rapidly rendering graphics. The renderer 236 and/or the projection system 216 use received operator image data and received environment image data to determine where and/or how AR data is displayed on the windshield. In other words, the renderer 236 and/or the projection system 216 may determine how to display AR data overlayed over the top of the external environment as viewed by the operator. Moreover, the renderer 236 and/or the projection system 216 are able to dynamically change display of the AR data as the car moves to maintain an appropriate perspective and angle relative to the operator as the vehicle moves.

The renderer 236 and/or the projection system 216 present a portion of AR data that is associated with an object that is in the environment ahead of the vehicle and that is likely within the central vision of the operator, based on a determined line of sight of the current gaze of the operator (determined by the gaze tracker). The renderer 236 and/or the projection system 216 can ensure that the AR data that is presented is displayed within, and pertains to an object that is likely within, the central vision of the operator, based on the determined line of sight of the current gaze of the operator. The renderer 236 and/or the projection system 216 may exclude or otherwise not display AR data pertaining to objects outside of the central vision of the operator, such as in the peripheral vision of the operator.

The operator identifier 238 may receive sensor data associated with the operator of the vehicle to identify an operator. By identifying the operator, pre-configured settings can be applied to enable the system 200 to operate correctly. For example, the operator identifier 238 may access stored head/eye position information for the identified operator. The head/eye position information may be provided to, for example, the gaze tracker for use in determining a line of sight of the operator's current gaze and/or provided to the renderer 236 and/or projection system 216 for use in correctly rendering the AR data on the windshield with the appropriate angle and perspective to the environment.

The sensor data used by the operator identifier 238 may be obtained by a plurality of sensors 252. The sensors 252 may include one or more of a radio frequency identification (RFID) tag reader, a bar code reader, a magnetic strip reader, a key fob reader, a weight sensor, a microphone (to detect audible tones of the operator), a seat belt length sensor, and an image sensor (e.g., the internal facing image capture system 210).

In the embodiment of FIG. 2, the gaze tracker 232, the environment analyzer 234, the renderer 236, and/or the operator identifier 238 may be implemented as software modules stored in the memory 222. In certain other embodiments, the environment analyzer 234, the renderer 236, and/or the operator identifier 238 may be implemented in hardware. In certain other embodiments, the environment analyzer 234, the renderer 236, and/or the operator identifier 238 may be implemented as a combination of software and hardware.

The controller 214 of the system 200 of FIG. 2 includes one or more I/O interfaces 240 to couple the controller 214 to external systems, such as the internal facing image capture system 210, the external facing image capture system 212, and the projection system 216. The I/O interfaces 240 may further couple the controller to one or more I/O devices, such as a microphone (to enable voice recognition/speech commands), a touchscreen, a trackball, a keyboard, or the like, which may enable an operator to configure the system 200 (e.g., pre-configure settings and/or preferences).

In the system 200 shown in FIG. 2, the controller 214 includes a network interface 218. In certain other embodiments, the network interface 218 may be external to and coupled to the controller 214. The network interface 218 is configured to form a wireless data connection with a wireless network access point (see access point 140 in FIGS. 1A and 1B). The network interface 218 receives AR data pertaining to the environment external to the vehicle. A portion of the received AR data may be pertinent to the environment visible to the operator through the windshield of the vehicle. For example, the network interface 218 may receive AR data pertinent to a parking stall near where the vehicle is travelling. The AR data may provide information concerning how much time is remaining before the parking meter expires. As described above with reference to FIGS. 1A-1C, the network interface 118 may connect with a wireless network access point coupled to a network, such as a local area network (LAN), a wide area network (WAN), or the Internet. In certain embodiments, the wireless network access point is on or coupled to a geographically localized network that is isolated from the Internet. In certain embodiments, the wireless network access point is coupled to a “cloudlet” of a cloud-based distributed computing network, or to another form of edge computing architecture of a cloud-based distributed computing network.

The projection system 216 projects the AR data on the windshield of the vehicle, utilizing the windshield as a HUD. The projection system 216 can present the AR data on the windshield to appear, to the operator of the vehicle, to be associated with a corresponding object that is in the environment ahead of the vehicle (e.g., relative to a direction of travel of the vehicle and/or in a direction that the operator is gazing). The projection system may adjust the brightness and/or transparency of the AR data that is displayed according to ambient lighting and/or user preference.

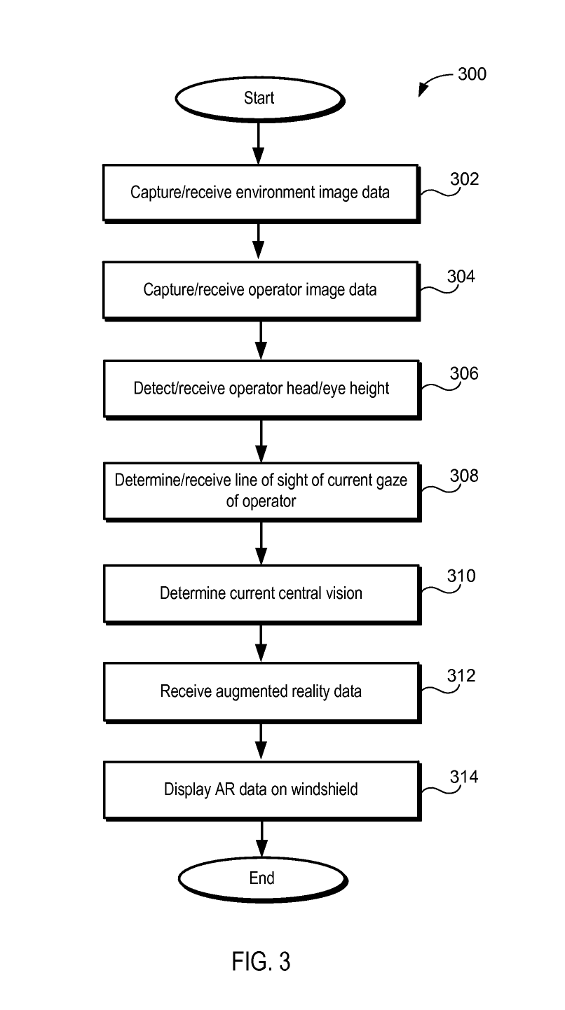

FIG. 3 is a flow diagram of a method 300 for presenting AR in a HUD using a windshield of a vehicle, according to one embodiment. Environment image data is captured 302 or otherwise received, such as via an external facing image capture system mounted to the vehicle. The environment image data includes image data for an environment visible to the operator through a windshield of the vehicle.

Operator image data may be captured 304 or otherwise received, such as via an internal facing image capture system mounted to the vehicle. The operator image data that is captured 304, or otherwise received, includes image data of the face and/or eyes of the operator. Optionally, the operator's head/eye position may be detected 306 from the operator image data. The operator image data may be processed to determine 308 a line of sight of a current gaze of the operator through the windshield of the vehicle. In certain embodiments, line of sight data may be received 308, such as from an external system. The line of sight data may specify the line of sight of the current gaze of the operator.

A current area of central vision of the operator may also be determined 310, based on the line of sight of the current gaze of the operator. Determining 310 the current area of central vision of the operator may include determining a visual field of the operator based on the line of sight data of the current gaze of the operator and then determining 310 the current area of central vision of the operator within the visual field. Determining the current area of central vision of the operator may account for size constraints of the windshield through which the operator is gazing.

AR data may be received 312, such as from a wireless network access point. At least a portion of the AR data may be pertinent to the environment visible to the operator through the windshield of the vehicle. The AR data may pertain to one or more objects in the environment visible to the operator.

A portion of the AR data is displayed 314 on the windshield of the vehicle based on the environment image data and based on the line of sight of the current gaze of the operator. The portion of AR data that is displayed may be associated with an object that is in the environment ahead of the vehicle and in a direction within the field of view corresponding to a direction of the line of sight of the operator. More particularly, the portion of AR data that is displayed may be associated with an object that is in the environment ahead of the vehicle and that is within the central vision of the operator, and the AR data is displayed on the windshield of the vehicle within the central vision of the operator. The portion of the AR data may be displayed on the windshield of the vehicle to appear, to the operator of the vehicle, to be associated with the corresponding object to which the AR data pertains.

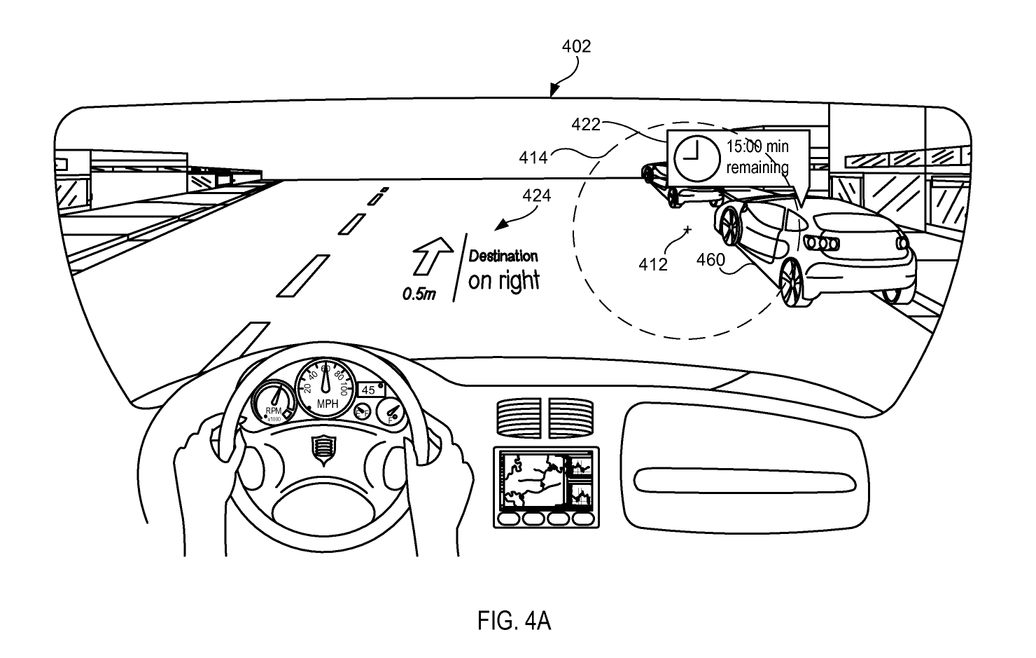

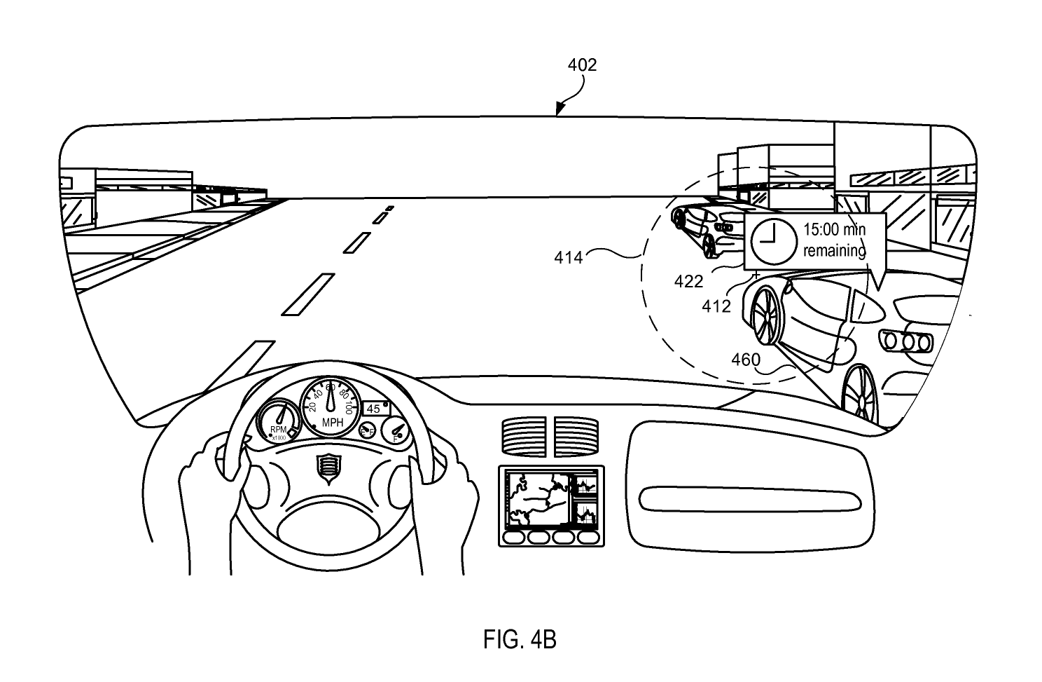

FIGS. 4A and 4B illustrate an example of a windshield 402 as a HUD, according to one embodiment, displaying AR data. FIGS. 4A and 4B also illustrate an example of a visual field of a driver of an automobile including a system for presenting AR data using the windshield 402 as a HUD. These figures illustrate gaze tracking and displaying AR data 422 at an appropriate perspective of the operator so as to appear associated with an object to which the AR data 422 pertains. These figures also illustrate displaying and/or rendering the AR data 422 in accordance with movement of the automobile (and correspondingly movement of the operator's field of view and a resulting shift of the operator's visual field).

In FIG. 4A, the operator's gaze, and correspondingly the line of sight 412 and central vision 414 of the operator's gaze, is directed toward a right side of the windshield 402. The system presents, on the windshield, AR data 422 associated with a parking spot near where the automobile is travelling. Specifically, the system is presenting AR data 422 indicating the time remaining on the parking meter for the parking spot. The AR data is displayed in association with the parking spot, or at least in association with the vehicle 460 parked in the parking spot, and conveys to the operator how long until the vehicle 460 may vacate the parking spot.

The system is also presenting destination AR data 424 such that it appears at the center of the windshield 402. The destination AR data 424 is outside the area of central vision 414 of the operator, but may be sufficiently near the area of central vision 414 that the system determines the destination AR data 424 can be displayed without significant distraction to the operator. In certain embodiments, the destination AR data 424 would be displayed within the area of central vision 414 of the operator. In certain embodiments, the destination AR data 424 is excluded, such that it is not displayed, because the gaze of the operator (and correspondingly the area of central vision 414 of the operator) is not directed out the center of the windshield 402. AR data pertaining to objects toward the left side of the operator's visual field is excluded or otherwise not displayed. The operator's gaze is directed to the right, and AR data associated with objects on the left may needlessly distract the operator.

In FIG. 4B, the automobile has advanced and also the operator's gaze has shifted further toward the right (possibly following the vehicle 460 with which the AR data 422 is associated). The line of sight 412 and central vision 414 of the operator's gaze are directed further toward the right side of the windshield 402. The AR data 422 remains displayed in close association with the parking spot or the vehicle 460 parked in the parking spot.

The system is no longer presenting destination AR data 424 because it is outside the area of central vision 414 of the operator and not sufficiently near the area of central vision 414 such that the system may determine the destination AR data 424 cannot be displayed without significant distraction to the operator. In certain embodiments, the destination AR data 424 may be displayed near or within the area of central vision 414 of the operator. AR data pertaining to objects toward the left side of the operator's visual field is excluded or otherwise not displayed. The operator's gaze is directed to the right, and AR data associated with objects on the left may needlessly distract the operator. Were the operator's gaze to shift to the left, the AR data 422 associated with the parking spot may be excluded and other AR data associated with objects toward the left may be displayed on the left side of the windshield 402.

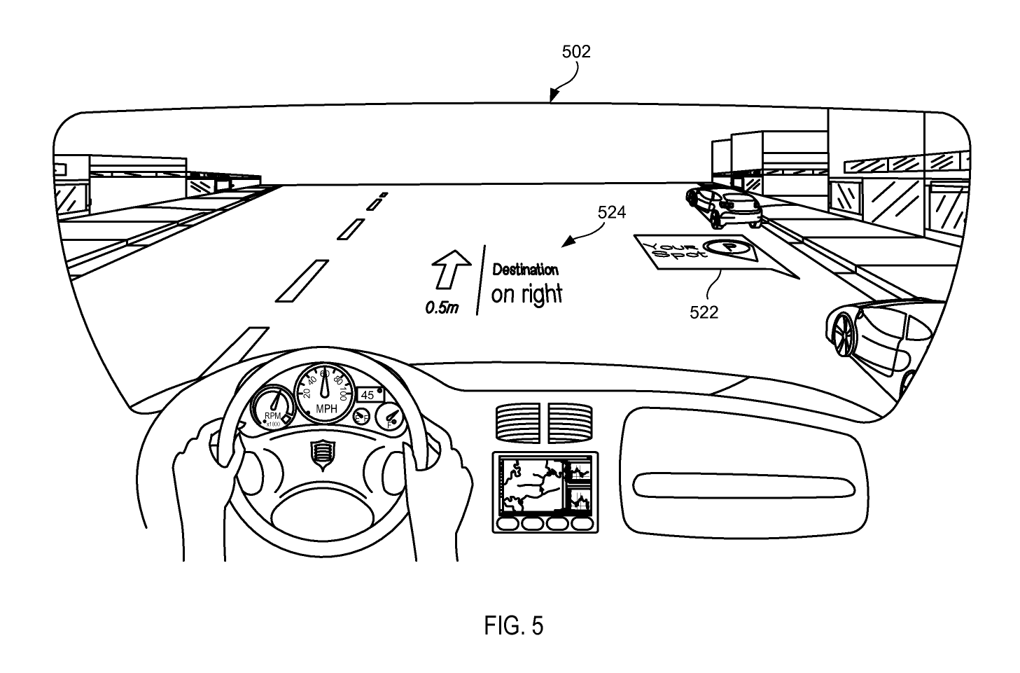

FIG. 5 illustrates another example of a windshield 502 as a HUD, according to another embodiment, displaying AR data. FIG. 5 also illustrates an example of a visual field of a driver of an automobile including a system for presenting AR data using the windshield 502 as a HUD. The operator's gaze may be directed toward a right side of the windshield 502. The system presents, on the windshield, AR data 522 associated with a parking spot near where the automobile is travelling. Specifically, the system is presenting AR data 522 indicating the parking spot is open and is a preferred spot for the operator to occupy in view of the operator's ultimate destination. The AR data 522 is displayed in association with and overlaid over the parking spot.

The system is also presenting destination AR data 524 such that it appears at the center of the windshield 502. The destination AR data 524 may be sufficiently near the area of central vision (not indicated) that the system determines the destination AR data 524 can be displayed without significant distraction to the operator. In certain embodiments, the destination AR data 524 would be displayed within the area of central vision of the operator. In certain other embodiments, the destination AR data 524 is excluded, such that it is not displayed, because the gaze of the operator (and correspondingly the area of central vision of the operator) is not directed out the center of the windshield 502. AR data pertaining to objects toward the left side of the operator's visual field is excluded or otherwise not displayed. The operator's gaze is directed to the right, and AR data associated with objects on the left may needlessly distract the operator. Were the operator's gaze to shift to the left, the AR data 522 associated with the parking spot may be excluded and other AR data associated with objects toward the left may be displayed on the left side of the windshield 502.

The AR data 522, 524 is displayed to appear overlaid or disposed on an object in the environment; in this case the road. In other words, the AR data is projected onto the windshield 502 to appear, to the operator of the vehicle, to be superimposed (e.g., as if painted) on the road ahead of the automobile. Displaying the AR data 522, 524 in this manner alleviates the possibility that AR data could occlude objects and may also visually associate the AR data with corresponding objects in the environment. This helps keep the driver's attention focused outward on the road instead of inside the vehicle or on a small HUD in a small portion of the windshield.

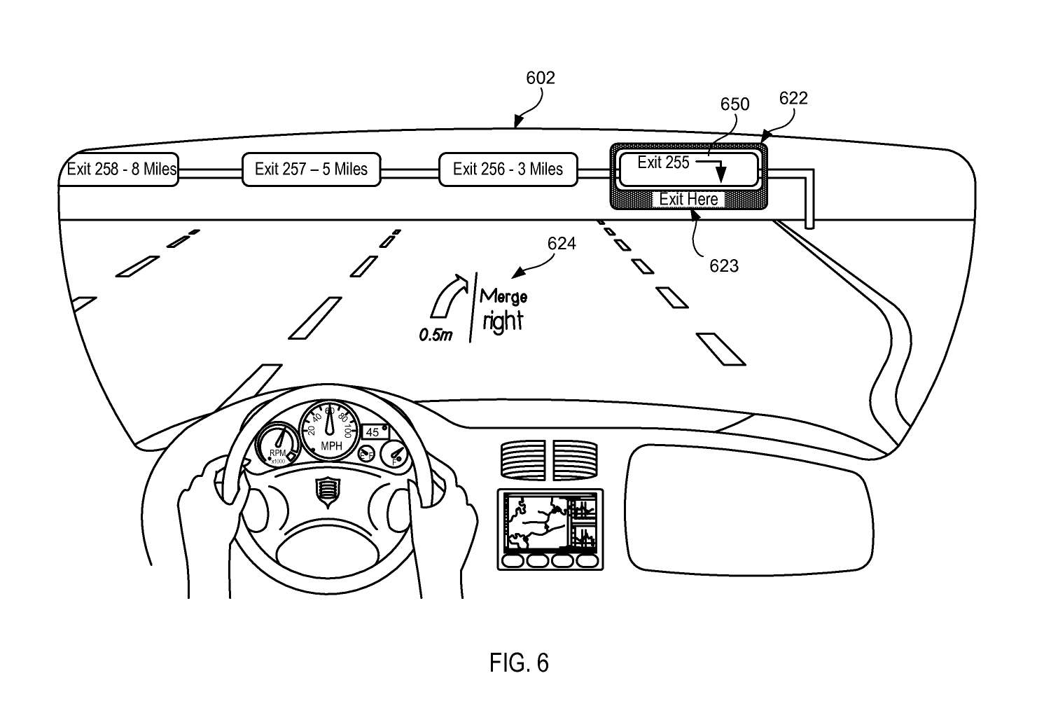

FIG. 6 illustrates yet another example of a windshield 602 as a HUD, according to one embodiment, displaying AR data. FIG. 6 also illustrates an example of a visual field of a driver of an automobile including a system for presenting AR data using the windshield 602 as a HUD. In FIG. 6, the system is displaying, at a top edge of the windshield 602, AR data associated with an exit sign 650. The AR data includes highlighting 622 that is displayed to appear superimposed over and/or around the exit sign 650 to indicate where the operator should exit the freeway to obtain a desired destination. The AR data also includes instructions 623 “Exit Here” to further instruct the operator where to exit the freeway to obtain the desired destination.

The AR data 622, 623 is displayed to appear overlaid or disposed on the exit sign 650 in the environment. In other words, the AR data is projected onto the windshield 602 to appear, to the operator of the vehicle, to be superimposed (e.g., as if painted) on the exit sign 650. Displaying the AR data 622, 623 in this manner alleviates the possibility that AR data could occlude other objects and may also visually associate the AR data 622, 623 with the corresponding exit sign 650 in the environment. This helps keep the driver's attention focused. Destination AR data 624 is also displayed to appear overlaid or disposed on the road.

### EXAMPLE EMBODIMENTS

### Example 1

A system for presenting augmented reality data in a head-up display of a vehicle, the system comprising: a gaze tracker to process operator image data of an operator of the vehicle to determine a current area of central vision of the operator; an environment analyzer to process environment image data of an environment visible to the operator through a windshield of the vehicle; and a projection system to present augmented reality data on a windshield of the vehicle, the projection system configured to present the augmented reality data that is associated with an object that is in the environment ahead of the vehicle and that is within the current area of central vision of the operator, wherein the augmented reality data is displayed on the windshield of the vehicle within the current area of central vision of the operator and displayed to appear, to the operator of the vehicle, to be associated with the object.

### Example 2

The system of example 1, further comprising a network interface to form a wireless data connection with a wireless network access point disposed externally to the vehicle and to receive, via the wireless data connection, augmented reality data pertinent to the environment visible to the operator through the windshield of the vehicle.

### Example 3

The system of any of examples 1-2, further comprising an internal facing image capture system to capture operator image data of the operator of the vehicle for processing by the gaze tracker.

### Example 4

The system of example 3, wherein the internal facing image capture system comprises an array camera.

### Example 5

The system of any of examples 1-4, further comprising an external facing image capture system to capture environment image data of an environment in front of the vehicle for processing by the environment analyzer.

### Example 6

The system of example 5, wherein the external facing image capture system comprises an array camera.

### Example 7

The system of any of examples 1-6, further comprising an operator identifier to receive sensor data associated with the operator of the vehicle obtained by a plurality of sensors.

### Example 8

The system of example 7, wherein the plurality sensors include one or more of a radio frequency identification (RFID) tag reader, a bar code reader, a magnetic strip reader, a key fob reader, a weight sensor, a microphone, a seat belt length sensor, and an image sensor.

### Example 9

The system of any of examples 1-8, wherein the projection system is configured to display the augmented reality data to appear, to the operator of the vehicle, to be superimposed on an object in the environment ahead of the vehicle.

### Example 10

The system of any of examples 1-9, wherein the system is configured to exclude from display on the windshield a portion of the augmented reality data that is associated with an object that is in the environment ahead of the vehicle and that is without the current area of central vision of the operator of the vehicle.

### Example 11

The system of any of examples 1-10, wherein the gaze tracker is configured to determine a line of sight of a current gaze of the operator of the vehicle, to determine a visual field of the operator based on the line of sight of the current gaze of the operator, and to determine the current area of central vision of the operator within the visual field.

### Example 12

The system of any of examples 1-11, wherein the wireless network access point is coupled to a cloudlet of a cloud-based distributed computing network.

### Example 13

The system of any of examples 1-12, wherein the wireless network access point is coupled to a fog of a cloud-based distributed computing network.

### Example 14

The system of any of examples 1-13, wherein the projection system is configured to present the augmented reality data at any area of the windshield, including adjacent all edges of the windshield, based on the current area of central vision of the operator.

### Example 15

A method of presenting augmented reality information to an operator of a vehicle, the method comprising: receiving environment image data from an external facing image capture system mounted to the vehicle, the environment image data including image data for an environment visible to the operator through a windshield of the vehicle; receiving data indicating a line of sight of a current gaze of the operator through a windshield of the vehicle; receiving augmented reality data pertinent to the environment visible to the operator; and displaying a portion of the augmented reality data on the windshield of the vehicle based on the environment image data and based on the line of sight of the current gaze of the operator, wherein the portion of the augmented reality data is associated with an object that is in the environment ahead of the vehicle and in a direction within the field of view corresponding to a direction of the line of sight of the operator, wherein the portion of the augmented reality data is displayed on the windshield of the vehicle corresponding to the line of sight of the operator and displayed to appear, to the operator of the vehicle, to be associated with the object.

### Example 16

The method of example 15, further comprising determining a current area of central vision of the operator, based on the line of sight of the current gaze of the operator, wherein the portion of the augmented reality data is associated with an object that is in the environment ahead of the vehicle and that is within the central vision of the operator, and wherein the portion of the augmented reality data is displayed on the windshield of the vehicle within the central vision of the operator.

### Example 17

The method of any of examples 15-16, wherein determining the current area of central vision of the operator includes: determining a visual field of the operator based on the line of sight of the current gaze of the operator; and determining the current area of central vision of the operator within the visual field.

### Example 18

The method of any of examples 15-17, wherein receiving augmented reality data comprises forming a wireless data connection with a wireless network access point.

### Example 19

The method of example 18, wherein the wireless network access point is on a geographically localized network that is isolated from the Internet.

### Example 20

The method of example 18, wherein the wireless network access point is coupled to a cloudlet of a cloud-based distributed computing network.

### Example 21

The method of example 18, wherein the wireless network access point is coupled to a fog of a cloud-based distributed computing network.

### Example 22

The method of any of examples 15-21, wherein the line of sight of the current gaze of the operator is determined by processing operator image data including the operator's face, the operator image data captured by an internal facing image capture system.

### Example 23

The method of any of examples 15-22, wherein receiving data specifying the line of sight of the current gaze of the operator comprises: receiving operator head position data; receiving operator image data from an internal facing image capture system mounted to the vehicle, the operator image data including image data of eyes of the operator; and processing the operator image data to determine a line of sight of the current gaze of the operator based on the operator head position data.

### Example 24

The method of example 23, wherein receiving operator head position data comprises: receiving sensor data associated with the operator of the vehicle, the sensor data obtained by a plurality of sensors; processing the sensor data to determine an identity of the operator of the vehicle; and retrieving head position data corresponding to the identity of the operator of the vehicle.

### Example 25

The method of example 24, wherein the plurality sensors include one or more of a radio frequency identification (RFID) tag reader, a bar code reader, a magnetic strip reader, a key fob reader, a weight sensor, a microphone, a seat belt length sensor, and an image sensor.

### Example 26

The method of any of examples 15-25, wherein displaying a portion of the augmented reality data on the windshield of the vehicle comprises displaying the augmented reality data to appear, to the operator of the vehicle, to be superimposed on an object in the environment ahead of the vehicle.

### Example 27

The method of any of examples 15-26, wherein displaying a portion of the augmented reality data on the windshield of the vehicle comprises the augmented reality data adjacent any edge of the windshield according to the line of sight of the current gaze of the operator.

### Example 28

The method of any of examples 15-27, further comprising occluding a portion of the augmented reality data that is associated with an object that is in the environment ahead of the vehicle and that is without central vision of the operator of the vehicle.

### Example 29

A non-transitory computer readable storage medium having stored thereon instructions that, when executed by a computing device, cause the computing device to perform the method of any of examples 15-28.

### Example 30

A system comprising means to implement the method of any one of examples 15-28.

### Example 31

A vehicle that presents augmented reality in a head-up display, the vehicle comprising: a windshield; an internal facing image capture system to capture operator image data of an operator of the vehicle; an external facing image capture system to capture environment image data of an environment in front of the vehicle; a gaze tracker to process operator image data to determine a line of sight of a current gaze of the operator of the vehicle; a network interface to form a wireless data connection with a wireless network access point disposed externally to the vehicle and to receive, via the wireless data connection, augmented reality data pertinent to the environment visible to the operator through the windshield of the vehicle; an environment analyzer to process environment image data captured by the external facing image capture system and correlate augmented reality data with one or more objects in the environment visible to the operator through the windshield of the vehicle; and a projection system to present augmented reality data on a windshield of the vehicle, the projection system configured to present a portion of augmented reality data that is associated with an object that is in the environment ahead of the vehicle and that is likely within the central vision of the operator, based on the line of sight of the current gaze of the operator, wherein the augmented reality data is displayed on the windshield of the vehicle corresponding to the line of sight of the operator and displayed to appear, to the operator of the vehicle, to be associated with the object.

### Example 32

The vehicle of example 31, wherein the internal facing image capture system comprises an array camera.

### Example 33

The vehicle of any of examples 31-32, wherein the external facing image capture system comprises an array camera.

### Example 34

The vehicle of any of examples exclude, further comprising an operator identifier to receive sensor data associated with the operator of the vehicle obtained by a plurality of sensors.

### Example 35

The vehicle of example 34, further comprising a plurality of sensors to provide data to the operator identifier, wherein the plurality sensors include one or more of a radio frequency identification (RFID) tag reader, a bar code reader, a magnetic strip reader, a key fob reader, a weight sensor, a microphone, a seat belt length sensor, and an image sensor.

### Example 36

The vehicle of any of examples 31-35, wherein the projection system is configured to display the augmented reality data to appear, to the operator of the vehicle, to be superimposed on an object in the environment ahead of the vehicle.

### Example 37

The vehicle of any of examples 31-36, wherein the system is configured to exclude from display on the windshield a portion of the augmented reality data that is associated with an object that is in the environment ahead of the vehicle and that is without the current area of central vision of the operator of the vehicle.

### Example 38

The vehicle of any of examples 31-37, wherein the gaze tracker is configured to determine a line of sight of a current gaze of the operator of the vehicle to determine a visual field of the operator based on the line of sight of the current gaze of the operator, and to determine the current area of central vision of the operator within the visual field.

### Example 39

The vehicle of any of examples 31-38, wherein the network interface is configured to form a wireless data connection with a wireless network access point that is coupled to a cloudlet of a cloud-based distributed computing network.

### Example 40

The vehicle of any of examples 31-39, wherein the network interface is configured to form a wireless data connection with a wireless network access point that is coupled to a fog of a cloud-based distributed computing network.

### Example 41

The vehicle of any of examples 31-40, wherein the projection system is configured to present the augmented reality data at any area of the windshield of the vehicle, including adjacent any edge of the windshield, according to the line of sight of the current gaze of the operator.

### Example 42

The vehicle of any of examples 31-41, wherein the projection system is configured to exclude from display on the windshield a portion of the augmented reality data that is associated with an object that is in the environment ahead of the vehicle and that is without a current area of central vision of the operator of the vehicle.

### Example 43

A method of presenting augmented reality information to an operator of a vehicle, the method comprising: receiving environment image data from an external facing image capture system mounted to the vehicle, the environment image data including image data for an environment visible to the operator through a windshield of the vehicle; receiving augmented reality data pertinent to the environment visible to the operator; tracking a current gaze of the operator through a windshield of the vehicle; and displaying a portion of the augmented reality data on the windshield of the vehicle based on the environment image data and within the current gaze of the operator, wherein the portion of the augmented reality data is associated with an object that is in the environment ahead of the vehicle and that is in a direction of the current gaze of the operator, wherein the portion of the augmented reality data is displayed on the windshield of the vehicle within the current gaze of the operator and displayed to appear, to the operator of the vehicle, to be associated with the object.

### Example 44

The method of example 43, wherein tracking the current gaze of the operator comprises: capturing image data of a face of the operator of the vehicle; and determining a line of sight of the current gaze of the operator, wherein the portion of the augmented reality data that is displayed is associated with an object that is in the environment ahead of the vehicle and in a direction of the line of sight of the current gaze of the operator.

### Example 45

The method of any of examples 43-44, wherein tracking the current gaze of the operator further comprises: determining a visual field of the operator based on the line of sight of the current gaze of the operator; and determining the current area of central vision of the operator within the visual field, wherein the portion of the augmented reality data that is displayed is associated with an object that is in the environment ahead of the vehicle and within the current area of central vision of the operator.

### Example 46

The method of any of examples 43-45, wherein receiving augmented reality data comprises forming a wireless data connection with a wireless network access point.

### Example 47

The method of example 46, wherein the wireless network access point is on a geographically localized network that is isolated from the Internet.

### Example 48

The method of example 46, wherein the wireless network access point is coupled to a cloudlet of a cloud-based distributed computing network.

### Example 49

The method of example 46, wherein the wireless network access point is coupled to a fog of a cloud-based distributed computing network.

### Example 50

The method of any of examples 43-49, wherein displaying a portion of the augmented reality data on the windshield of the vehicle comprises displaying the augmented reality data to appear, to the operator of the vehicle, to be superimposed on an object in the environment ahead of the vehicle.

### Example 51

The method of any of examples 43-50, wherein displaying a portion of the augmented reality data on the windshield of the vehicle comprises the augmented reality data adjacent any edge of the windshield according to the current gaze of the operator.

### Example 52

The method of any of examples 43-51, further comprising occluding a portion of the augmented reality data that is associated with an object that is in the environment ahead of the vehicle and that is without the current gaze of the operator of the vehicle.

### Example 53

A system for presenting augmented reality data in a head-up display of a vehicle, the system comprising: means for tracking a current gaze of an operator, wherein the gaze tracking means process operator image data of an operator of the vehicle to determine a current area of central vision of the operator; means for analyzing an environment visible to the operator through a windshield of the vehicle, the environment analyzing means configured to process environment image data of the environment visible to the operator through the windshield of the vehicle; and means for projecting augmented reality data on a windshield of the vehicle, the projecting means configured to present the augmented reality data that is associated with an object that is in the environment ahead of the vehicle and that is within the current area of central vision of the operator, wherein the augmented reality data is displayed on the windshield of the vehicle within the current area of central vision of the operator and displayed to appear, to the operator of the vehicle, to be associated with the object.

### Example 54

The system of example 53, wherein the gaze tracking comprises a gaze tracker system.

### Example 55

The system of any of examples 53-54, wherein the environment analyzing means comprises an environment analyzer system.

### Example 56

The system of any of examples 53-55, wherein the projecting means comprises a projector.

### Example 57

The system of any of examples 53-56, further comprising a means for networking to form a wireless data connection with a wireless network access point disposed externally to the vehicle and to receive, via the wireless data connection, augmented reality data pertinent to the environment visible to the operator through the windshield of the vehicle.

### Example 58

The system of example 57, wherein the networking means comprises a network interface system.

### Example 59

The system of any of example 53-58, further comprising means for capturing internal facing image data of the operator of the vehicle for processing by the gaze tracking means.

### Example 60

The system of example 59, wherein the internal facing capturing means comprises an internal facing array camera

### Example 61

The system of any of examples 53-60, further comprising means for capturing external facing image data of an environment in front of the vehicle for processing by the environment analyzer.

### Example 62

The system of example 61, wherein the external facing capturing means comprises an external facing array camera.

The embodiments described above are described with reference to an operator of a vehicle and to a windshield in front of the operator in a typical direction (e.g., forward direction) of travel. In other embodiments, AR data may be displayed to another occupant of the vehicle, such as a front passenger. In still other embodiments, AR data may be displayed on a window of the vehicle other than the windshield. For example, AR data may be presented on side windows for rear passengers to observe and benefit from. In other words, an internal facing image capture system may be directed to any occupant of a vehicle and an external facing image capture system may be directed in any direction from the vehicle.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer-executable code located within a memory device and/or computer-readable storage medium. A software module may, for instance, comprise one or more physical or logical blocks of computer instructions, which may be organized as a routine, a program, an object, a component, a data structure, etc., that perform one or more tasks or implement particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be obvious to those having skill in the art that many changes may be made to the details of the above-described embodiments without departing from the underlying principles of the invention. The scope of the present invention should, therefore, be determined only by the following claims.

We claim:

1.-25. (canceled)

26. A system for presenting augmented reality data in a head-up display of a vehicle, the system comprising:
a gaze tracker to process operator image data of an operator of the vehicle to determine a current area of central vision of the operator;
an environment analyzer to process environment image data of an environment visible to the operator through a windshield of the vehicle; and\
a projection system to present augmented reality data on a windshield of the vehicle, the projection system configured to present the augmented reality data that is associated with an object that is in the environment ahead of the vehicle and that is within the current area of central vision of the operator, wherein the augmented reality data is displayed on the windshield of the vehicle within the current area of central vision of the operator and displayed to appear, to the operator of the vehicle, to be associated with the object.

27. The system of claim 26, further comprising a network interface to form a wireless data connection with a wireless network access point disposed externally to the vehicle and to receive, via the wireless data connection, augmented reality data pertinent to the environment visible to the operator through the windshield of the vehicle.

28. The system of claim 26, further comprising an internal facing image capture system to capture operator image data of the operator of the vehicle for processing by the gaze tracker.

29. The system of claim 26, further comprising an external facing image capture system to capture environment image data of an environment in front of the vehicle for processing by the environment analyzer.

30. The system of claim 26, further comprising an operator identifier to receive sensor data associated with the operator of the vehicle obtained by a plurality of sensors.

31. The system of claim 26, wherein the projection system is configured to display the augmented reality data to appear, to the operator of the vehicle, to be superimposed on an object in the environment ahead of the vehicle.

32. The system of claim 26, wherein the system is configured to exclude from display on the windshield a portion of the augmented reality data that is associated with an object that is in the environment ahead of the vehicle and that is without the current area of central vision of the operator of the vehicle.

33. The system of claim 26, wherein the gaze tracker is configured to determine a line of sight of a current gaze of the operator of the vehicle, to determine a visual field of the operator based on the line of sight of the current gaze of the operator, and to determine the current area of central vision of the operator within the visual field.

34. The system of claim 26, wherein the wireless network access point is coupled to a cloudlet of a cloud-based distributed computing network.

35. The system of claim 26, wherein the projection system is configured to present the augmented reality data at any area of the windshield, including adjacent all edges of the windshield, based on the current area of central vision of the operator.

36. A method of presenting augmented reality information to an operator of a vehicle, the method comprising:
receiving environment image data from an external facing image capture system mounted to the vehicle, the environment image data including image data for an environment visible to the operator through a windshield of the vehicle;
receiving data indicating a line of sight of a current gaze of the operator through a windshield of the vehicle;
receiving augmented reality data pertinent to the environment visible to the operator; and
displaying a portion of the augmented reality data on the windshield of the vehicle based on the environment image data and based on the line of sight of the current gaze of the operator, wherein the portion of the augmented reality data is associated with an object that is in the environment ahead of the vehicle and in a direction within the field of view corresponding to a direction of the line of sight of the operator, wherein the portion of the augmented reality data is displayed on the windshield of the vehicle corresponding to the line of sight of the operator and displayed to appear, to the operator of the vehicle, to be associated with the object.

37. The method of claim 36, further comprising determining a current area of central vision of the operator, based on the line of sight of the current gaze of the operator,
wherein the portion of the augmented reality data is associated with an object that is in the environment ahead of the vehicle and that is within the central vision of the operator, and
wherein the portion of the augmented reality data is displayed on the windshield of the vehicle within the central vision of the operator.

38. The method of claim 37, wherein determining the current area of central vision of the operator includes:
determining a visual field of the operator based on the line of sight of the current gaze of the operator; and
determining the current area of central vision of the operator within the visual field.

39. The method of claim 36, wherein receiving augmented reality data comprises forming a wireless data connection with a wireless network access point.

40. The method of claim 36, wherein the line of sight of the current gaze of the operator is determined by processing operator image data including the operator's face, the operator image data captured by an internal facing image capture system.

41. The method of claim 36, wherein receiving data specifying the line of sight of the current gaze of the operator comprises:
receiving operator head height data;
receiving operator image data from an internal facing image capture system mounted to the vehicle, the operator image data including image data of eyes of the operator; and
processing the operator image data to determine a line of sight of the current gaze of the operator based on the operator head height data.

42. The method of claim 41, wherein receiving operator head height data comprises:
receiving sensor data associated with the operator of the vehicle, the sensor data obtained by a plurality of sensors;
processing the sensor data to determine an identity of the operator of the vehicle; and
retrieving head height data corresponding to the identity of the operator of the vehicle.

43. The method of claim 36, wherein displaying a portion of the augmented reality data on the windshield of the vehicle comprises the augmented reality data adjacent any edge of the windshield according to the line of sight of the current gaze of the operator.

44. The method of claim 36, further comprising occluding a portion of the augmented reality data that is associated with an object that is in the environment ahead of the vehicle and that is without central vision of the operator of the vehicle.

45. A vehicle that presents augmented reality in a head-up display, the vehicle comprising:
a windshield;
an internal facing image capture system to capture operator image data of an operator of the vehicle;
an external facing image capture system to capture environment image data of an environment in front of the vehicle;
a gaze tracker to process operator image data to determine a line of sight of a current gaze of the operator of the vehicle;
a network interface to form a wireless data connection with a wireless network access point disposed externally to the vehicle and to receive, via the wireless data connection, augmented reality data pertinent to the environment visible to the operator through the windshield of the vehicle;
an environment analyzer to process environment image data captured by the external facing image capture system and correlate augmented reality data with one or more objects in the environment visible to the operator through the windshield of the vehicle; and
a projection system to present augmented reality data on a windshield of the vehicle, the projection system configured to present a portion of augmented reality data that is associated with an object that is in the environment ahead of the vehicle and that is likely within the central vision of the operator, based on the line of sight of the current gaze of the operator, wherein the augmented reality data is displayed on the windshield of the vehicle corresponding to the line of sight of the operator and displayed to appear, to the operator of the vehicle, to be associated with the object.

46. A non-transitory computer readable storage medium having stored thereon instructions that, when executed by a computing device, cause the computing device to perform operations comprising:
receiving environment image data from an external facing image capture system mounted to the vehicle, the environment image data including image data for an environment visible to the operator through a windshield of the vehicle;
receiving data indicating a line of sight of a current gaze of the operator through a windshield of the vehicle;
receiving augmented reality data pertinent to the environment visible to the operator; and
displaying a portion of the augmented reality data on the windshield of the vehicle based on the environment image data and based on the line of sight of the current gaze of the operator, wherein the portion of the augmented reality data is associated with an object that is in the environment ahead of the vehicle and in a direction within the field of view corresponding to a direction of the line of sight of the operator, wherein the portion of the augmented reality data is displayed on the windshield of the vehicle corresponding to the line of sight of the operator and displayed to appear, to the operator of the vehicle, to be associated with the object.

47. The computer readable storage medium of claim 46, further having stored thereon instructions that, when executed by a computing device, cause the computing device to perform operations comprising:
determining a current area of central vision of the operator, based on the line of sight of the current gaze of the operator,
wherein the portion of the augmented reality data is associated with an object that is in the environment ahead of the vehicle and that is within the central vision of the operator, and
wherein the portion of the augmented reality data is displayed on the windshield of the vehicle within the central vision of the operator.

48. The computer readable storage medium of claim 46, wherein receiving augmented reality data comprises forming a wireless data connection with a wireless network access point.

49. The computer readable storage medium of claim 46, further having stored thereon instructions that, when executed by a computing device, cause the computing device to perform operations comprising:
excluding a portion of the augmented reality data that is associated with an object that is in the environment ahead of the vehicle and that is without central vision of the operator of the vehicle.

50. A system for presenting augmented reality data in a head-up display of a vehicle, the system comprising:
means for tracking a current gaze of an operator, wherein the gaze tracking means process operator image data of an operator of the vehicle to determine a current area of central vision of the operator;
means for analyzing an environment visible to the operator through a windshield of the vehicle, the environment analyzing means configured to process environment image data of the environment visible to the operator through the windshield of the vehicle; and
means for projecting augmented reality data on a windshield of the vehicle, the projecting means configured to present the augmented reality data that is associated with an object that is in the environment ahead of the vehicle and that is within the current area of central vision of the operator, wherein the augmented reality data is displayed on the windshield of the vehicle within the current area of central vision of the operator and displayed to appear, to the operator of the vehicle, to be associated with the object.
